(19) United States
(12) Patent Application Publication
(10) Pub. No.: US 2005/0154506 A1
(43) Pub. Date: Jul. 14, 2005

(54) Vehicle integrated control system

(75) Inventor: Hideki Takamatsu, Anjo-shi (JP)

Correspondence Address: OLIFF & BERRIDGE, PLC, P.O. BOX 19928, ALEXANDRIA, VA, 22320, US

(73) Assignee: TOYOTA JIDOSHA KABUSHIKI KAISHA, Toyota-shi (JP)

(21) Appl. No.: 11/017,158

(22) Filed: Dec. 21, 2004

(30) Foreign Application Priority Data
Jan. 8, 2004 (JP) 2004-003104

(51) Int. Cl. G06F 7/00

(52) U.S. Cl. 701/1; 701/93

(57) ABSTRACT

An integrated control system includes processes A-C in which request acceleration, target gear ratio, and target engine revolution are calculated in accordance with the HMI in a main control system (accelerator) controlling the driving system, and processes D-F in which the request acceleration, target gear ratio, and target engine revolution are calculated in accordance with a manual manipulation request where the driver upshifts or downshifts the gear of the transmission, for example, that is an actuator.

This nonprovisional application is based on Japanese Patent Application No. 2004-003104 filed with the Japan Patent Office on Jan. 8, 2004, the entire contents of which are hereby incorporated by reference.

### BACKGROUND OF THE INVENTION

1. Field of the Invention

The present invention relates to a system controlling a plurality of actuators incorporated in a vehicle, and more particularly, a system controlling in an integrated manner a plurality of actuators with the possibility of mutual interference.

2. Description of the Related Art

There has been an increasing trend in recent years towards incorporating many types of motion control devices in the same vehicle to control the motion of the vehicle. The effect produced by each of the different types of motion control devices may not always emerge in a manner independent of each other at the vehicle. There is a possibility of mutual interference. It is therefore important to sufficiently organize the interaction and coordination between respective motion control devices in developing a vehicle that incorporates a plurality of types of motion control devices.

For example, when it is required to incorporate a plurality of types of motion control devices in one vehicle in the development stage of a vehicle, it is possible to develop respective motion control devices independently of each other, and then implement the interaction and coordination between respective motion control devices in a supplemental or additional manner.

In the case of developing a plurality of types of motion control devices in the aforesaid manner, organization of the interaction and coordination between respective motion control devices requires much time and effort.

With regards to the scheme of incorporating a plurality of types of motion control devices in a vehicle, there is known the scheme of sharing the same actuator among the motion control devices. This scheme involves the problem of how the contention among the plurality of motion control devices, when required to operate the same actuator at the same time, is to be resolved.

In the above-described case where the interaction and coordination among a plurality of motion control devices are to be organized in a supplemental or additional manner after the motion control devices are developed independently of each other, it is difficult to solve the problem set forth above proficiently. In practice, the problem may be accommodated only by selecting an appropriate one of the plurality of motion control devices with precedence over the others, and dedicate the actuator to the selected motion control device alone.

An approach related to the problem set forth above in a vehicle incorporating a plurality of actuators to drive a vehicle in the desired behavior is disclosed in the following publications.

Japanese Patent Laying-Open No. 5-85228 (Document 1) discloses an electronic control system of a vehicle that can reduce the time required for development, and that can improve the reliability, usability, and maintenance feasibility of the vehicle. This electronic control system for a vehicle includes elements coacting for carrying out control tasks with reference to engine power, drive power and braking operation, and elements for coordinating the coaction of the elements to effect a control of operating performance of the motor vehicle in correspondence to a request of the driver. Respective elements are arranged in the form of a plurality of hierarchical levels. At least one of the coordinating elements of the hierarchical level is adapted for acting on the element of the next hierarchical level when translating the request of the driver into a corresponding operating performance of the motor vehicle thereby acting on a pre-given subordinate system of the driver-vehicle system while providing the performance required from the hierarchical level for this subordinate system.

By organizing the entire system in a hierarchy configuration in accordance with this electronic control system for a vehicle, an instruction can be conveyed only in the direction from an upper level to a lower level. The instruction to execute the driver's request is transmitted in this direction. Accordingly, a comprehensible structure of elements independent of each other is achieved. The linkage of individual systems can be reduced to a considerable level. The independency of respective elements allows the individual elements to be developed concurrently at the same time. Therefore, each element can be developed in accordance with a predetermined object. Only a few interfaces with respect to the higher hierarchical level and a small number of interfaces for the lower hierarchical level have to be taken into account. Accordingly, optimization of the totality of the driver and the vehicle electronic control system with respect to energy consumption, environmental compatibility, safety and comfort can be achieved. As a result, a vehicle electronic control system can be provided, allowing reduction in the development time, and improvement in reliability, usability, and maintenance feasibility of a vehicle.

Japanese Patent Laying-Open No. 2003-191774 (Document 2) discloses a integrated type vehicle motion control device adapting in a hierarchy manner a software configuration for a device that controls a plurality of actuators in an integrated manner to execute motion control of a plurality of different types in a vehicle, whereby the hierarchy structure is optimized from the standpoint of practical usage.

In accordance with this integrated type vehicle motion control device, at least the software configuration is organized in hierarchal levels such that the control unit and the execution unit are separated from each other. Since the control unit and the execution unit are independent of each other from the software configuration perspective, the period of the working stage such as development, designing, design modification, debugging and the like can be readily shortened.

The control devices disclosed in Document 1 and Document 2 do not specifically discloses the coordination control of driving and brakes in vehicle motion control.

### SUMMARY OF THE INVENTION

In view of the foregoing, an object of the present invention is to provide a vehicle integrated control system that can properly reflect a request corresponding to manual manipulation by a driver even when automatic cruising is conducted in such a vehicle integrated control system.

A vehicle integrated control system according to an aspect of the present invention includes a plurality of control units operating autonomously for controlling the running state of a vehicle based on a manipulation request. Each control unit includes a sensing unit for sensing a driver's request and a controller for controlling the vehicle by generating a control target based on a request and manipulating an actuator set in correspondence with each unit. The system further includes a processing unit generating and providing to each of the control units information used to accommodate a direct request to wards the actuator by the driver. This information is priority information used in priority over a control target generated at the controller.

According to the present invention, the plurality of control units include, for example, any of a driving system control unit, a brake system control unit, and a steering system control unit. The driving system control unit senses an accelerator pedal manipulation that is a request of a driver through the sensing unit to generate a control target of the driving system corresponding to the accelerator pedal manipulation using a driving basic driver model, whereby a power train that is an actuator is controlled by the controller. The brake system control unit senses a brake pedal manipulation that is a request of the driver through the sensing unit to generate a control target of the brake system corresponding to the brake pedal manipulation using a brake basic driver model, whereby a brake device that is an actuator is controlled by the controller. The steering system control unit senses a steering manipulation that is a request of the driver through the sensing unit to generate a control target of the steering system corresponding to the steering manipulation using a steering basic driver model, whereby a steering device that is an actuator is controlled by the controller. The vehicle integrated control system includes a processing unit that operates parallel to the driving system control unit, brake system control unit, and steering system control unit that operate autonomously. The processing unit generates information to be used to accommodate a direct request to wards an actuator by the driver. This information is used in priority over the control target generated at the controller. Therefore, in the driving system control unit corresponding to a “running” operation that is the basic operation of a vehicle, the brake system control unit corresponding to a “stop” operation, and the steering system control unit corresponding to a “turning” operation in a system that controls the vehicle in an integrated manner, the request of the driver wishing to directly control the actuator can be realized. The vehicle integrated control system can properly accommodate the driver's own judgment to control the actuator directly through the processing unit.

Preferably, the processing unit includes a generation unit generating priority information based on environmental information around the vehicle, and a direct request.

In accordance with the present invention, the direct request by the driver can be corrected to generate priority information based on environmental information around the vehicle such as the inclination and/or curvature of the corner of the currently-running road, the friction coefficient of the currently-running road, the relative speed and/or distance alteration between one's vehicle and the vehicle running ahead. Accordingly, high running control ability can be maintained while giving the driver's request priority.

Further preferably, the environmental information includes information related to the road on which the vehicle runs.

For example, when extreme acceleration or abrupt steering is requested when the inclination of the road is a down-climbing road, or an abrupt curve that has a high corner curvature is right ahead, or the friction coefficient of the currently-running road is low, the priority information is calculated in a corrected manner to moderate the request.

Further preferably, the environmental information includes information related to another vehicle in the neighborhood.

In the case where the accelerator pedal is stepped down greatly or downshift that generates great acceleration in a manual shift control mode is selected even though the relative distance from the vehicle running ahead becomes smaller, the priority information is calculated in a corrected manner so as to moderate the request.

Further preferably, each controller generates a control target based on a request even in the case where the vehicle is controlled in an integrated manner with the priority information used in each control unit.

The present invention allows continuous generation of a control target based on the request sensed at respective control units of the driving system control unit, brake system control unit, and steering system control unit that operate autonomously even in the case where priority information is used in respective control units for vehicle integrated control. Each control unit senses the driver's request to generate a control target based on the request even if the vehicle is under control in accordance with priority information. This allows immediate return to the normal integrated control by respective control units when the request of actuator direct control by the driver is withdrawn.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram of a vehicle in which the vehicle integrated control system of the present embodiment is incorporated.

FIG. 2 is a schematic diagram of a configuration of the vehicle integrated control system according to the present embodiment.

FIG. 3 is a schematic diagram of a configuration of a main control system (1).

FIG. 4 is a diagram representing the input and output of signals in a main control system (1).

FIG. 5 is a diagram representing the input and output of signals in a main control system (2).

FIG. 6 is a diagram representing the input and output of signals in a main control system (3).

FIG. 7 represents a control configuration of a first specific example of a main control system (1).

FIG. 8 is a flow chart of a control configuration of the main program executed by an ECU realizing a second specific example of a main control system (1).

FIGS. 9-14 are flow charts of a control configuration of the subroutine programs of FIG. 8.

### DESCRIPTION OF THE PREFERRED EMBODIMENTS

An embodiment of the present invention will be described hereinafter with reference to the drawings. The same elements have the same reference characters allotted. Their label and function are also identical. Therefore, detailed description thereof will not be repeated.

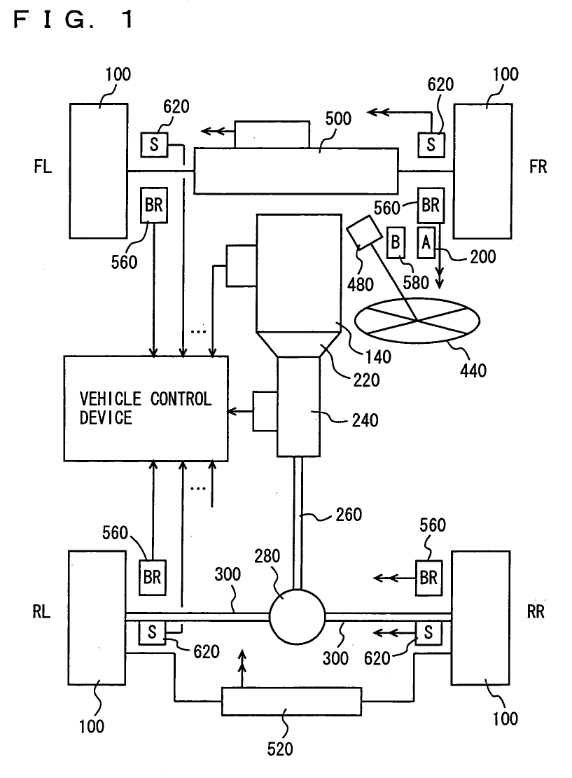

Referring to the block diagram of FIG. 1, a vehicle integrated control system according to an embodiment of the present invention has an internal combustion engine incorporated in a vehicle as a driving power source. The driving power source is not restricted to an internal combustion engine, and may be an electric motor alone, or a combination of an engine and an electric motor. The power source of the electric motor may be a secondary battery or a cell.

The vehicle includes wheels 100 at the front and back of respective sides. In FIG. 1, “FL” denotes a front-left wheel, “FR” denotes a front-right wheel, “RL” denotes a left-rear wheel, and “RR” denotes a rear-right wheel.

The vehicle incorporates an engine 140 as a power source. The operating state of engine 140 is electrically controlled in accordance with the amount or level by which the accelerator pedal (which is one example of a member operated by the driver related to the vehicle drive) is manipulated by the driver. The operating state of engine 140 is controlled automatically, as necessary, irrespective of the manipulation of accelerator pedal 200 by the driver (hereinafter referred to as “driving operation” or “accelerating operation”).

The electric control of engine 140 may be implemented by, for example, electrically controlling an opening angle (that is, a throttle opening) of a throttle valve disposed in an intake manifold of engine 140, or by electrically controlling the amount of fuel injected into the combustion chamber of engine 140.

The vehicle of the present embodiment is a rear-wheel-drive vehicle in which the right and left front wheels are driven wheels, and the right and left rear wheels are driving wheels. Engine 140 is connected to each of the rear wheels via a torque converter 220, a transmission 240, a propeller shaft 260 and a differential gear unit 280 as well as a drive shaft 300 that rotates with each rear wheel, all arranged in the order of description. Torque converter 220, transmission 240, propeller shaft 260 and differential gear 280 are power transmitting elements that are common to the right and left rear wheels.

Transmission 240 includes an automatic transmission that is not shown. This automatic transmission electrically controls the gear ratio at which the revolution speed of engine 140 is changed to the speed of rotation of an output shaft of transmission 240.

The vehicle further includes a steering wheel 440 adapted to be turned by the driver. A steering reaction force applying device 480 electrically applies a steering reaction force corresponding to a turning manipulation by the driver (hereinafter, referred to as “steering”) to steering wheel 440. The level of the steering reaction force is electrically controllable.

The direction of the right and left front wheels, i.e. the front-wheel steering angle is electrically altered by a front steering device 500. Front steering device 50 controls the front-wheel steering angle based on the angle, or steering wheel angle, by which steering wheel 440 is turned by the driver. The front-rear steering angle is controlled automatically, as necessary, irrespective of the turning operation. In other words, steering wheel 440 is mechanically insulated from the right and left front wheels.

The direction of the left and right wheels, i.e., the rear-wheel steering angle, is electrically altered by a rear steering device 520, likewise the front-wheel steering angle.

Each wheel 100 is provided with a brake 560 that is actuated so as to restrict its rotation. Each brake 560 is electrically controlled in accordance with the operated amount of a brake pedal 580 (which is one example of a member operated by the driver related to vehicle braking), and also controlled individually for each wheel 100 automatically.

In the present vehicle, each wheel 100 is suspended to the vehicle body (not shown) via each suspension 620. The suspending characteristics of respective suspension 620 is electrically controllable individually.

The constituent elements of the vehicle set forth above include an actuator adapted to be operated so as to electrically actuate respective elements as follows:
(1) An actuator to electrically control engine 140;
(2) An actuator to electrically control transmission 240;
(3) An actuator to electrically control steering reaction force applying device 480;
(4) An actuator to electrically control front steering device 500;
(5) An actuator to electrically control rear steering device 520;
(6) A plurality of actuators provided in association with respective brakes 560 to electrically control the braking torque applied to each wheel by a corresponding brake 560 individually;
(7) A plurality of actuators provided in association with respective suspensions 620 to electrically control the suspending characteristics of a corresponding suspension 620 individually.

As shown in FIG. 1, the vehicle integrated control system is incorporated in a vehicle having the aforesaid plurality of actuators connected. The motion control device is actuated by the electric power supplied from a battery not shown (which is an example of the vehicle power supply).

Additionally, an accelerator pedal reaction force applying device may be provided for accelerator pedal 200. In this case, an actuator to electrically control such an accelerator pedal reaction force applying device is to be provided.

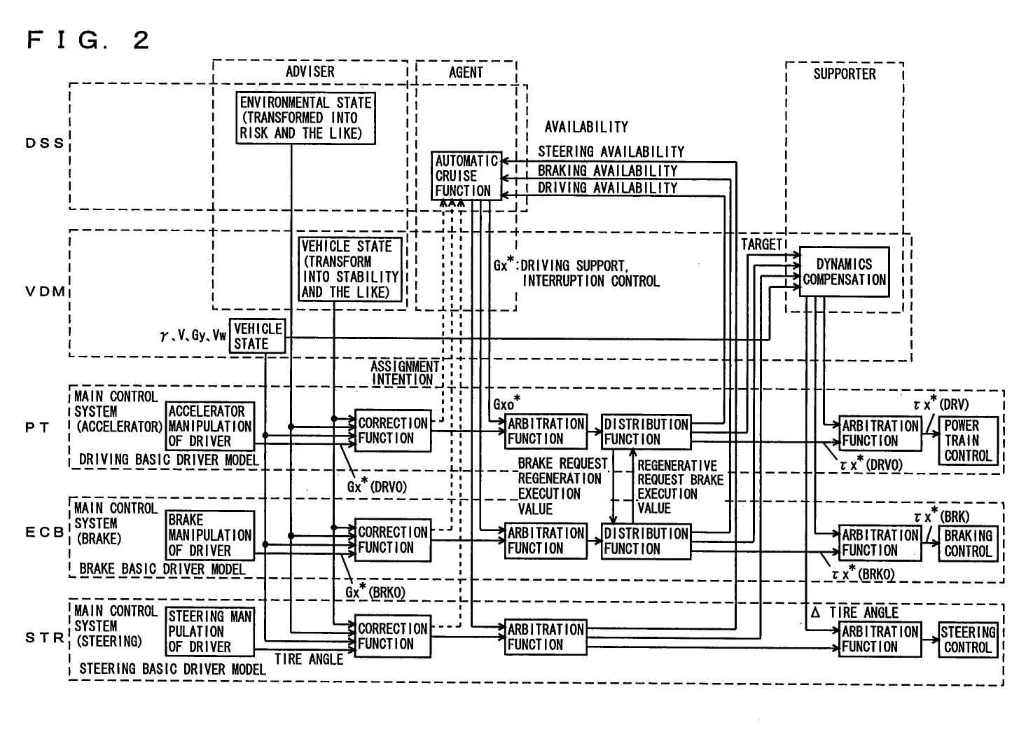

FIG. 2 is a schematic diagram of a configuration of the vehicle integrated control system. The vehicle integrated control system is formed of three basic control units, i.e. a main control system (1) as the driving system control unit, a main control system (2) as the brake system control unit, and a main control system (3) as the steering system control unit.

At main control system (1) identified as the driving system control unit, a control target of the driving system corresponding to accelerator pedal manipulation is generated using the driving basic driver model, based on the accelerator pedal manipulation that is the sensed request of the driver, whereby the actuator is controlled. At main control system (1), the input signal from the sensor to sense the accelerator pedal operated level of the driver (stroke) is analyzed using the drive basic model to calculate a target longitudinal acceleration Gx*(DRV0). The target longitudinal acceleration Gx*(DRV0) is corrected by a correction functional block based on the information from an adviser unit. Further, target longitudinal acceleration Gx* (DRV0) is arbitrated by the arbitration functional block based on the information from an agent unit. Further, the driving torque and braking torque is distributed with main control system (2), and the target driving torque τx*(DRV0) of the driving side is calculated. Further, the target driving torque τx*(DRV0) is arbitrated by the arbitration functional block based on information from a supporter unit, and a target driving torque τx*(DRV) is calculated. The power train (140, 220, 240) is controlled so as to develop this target driving torque τx*(DRV).

At main control system (2) identified as the brake system control unit, a control target of the brake system corresponding to the brake pedal manipulation is generated using the brake basic driver model based on the brake pedal manipulation that is the sensed request of the driver, whereby the actuator is controlled.

At main control system (2), the input signal from a sensor to sense the brake pedal manipulated level (depression) of the driver is analyzed using a brake basic model to calculate a target longitudinal acceleration Gx*(BRK0). At main control system (2), the target longitudinal acceleration Gx*(BRK0) is corrected by a correction functional block based on the information from the adviser unit. Further at main control system (2), the target longitudinal acceleration Gx*(BRK0) is arbitrated by the arbitration functional block based on the information from the agent unit. Further at main control system (2), the driving torque and the braking torque are distributed with main control system (1), and the target braking torque τx*(BRK0) of the braking side is calculated. Further, the target braking torque τx*(BRK0) is arbitrated by the arbitration functional block based on the information from the support unit, and target braking torque τx* (BRK) is calculated. The actuator of brake 560 is controlled so as to develop this target braking torque τx*(BRK).

At main control system (3) identified as the steering system control unit, a control target of the steering system corresponding to the steering manipulation is generated using the steering brake basic driver model based on the steering manipulation that is the sensed request of the driver, whereby the actuator is controlled.

At main control system (3), an input signal from the sensor to sense the steering angle of the driver is analyzed using a steering basic model to calculate a target tire angle. The target tire angle is corrected by the correction functional block based on the information from the adviser unit. Further, the target tire angle is arbitrated by the arbitration functional block based on the information from the agent unit. Further, the target tire angle is arbitrated by the arbitration functional block based on the information from the supporter unit to calculate the target tire angle. The actuators of front steering device 500 and rear steering device 520 are controlled so as to develop the target tire angle.

Furthermore, the present vehicle integrated control system includes a plurality of processing units parallel to main control system (1) (driving system control unit), main control system (2) (brake system unit) and main control system (3) (steering system control unit), operating autonomously. The first processing unit is an adviser unit with an adviser function. The second processing unit is an agent unit with an agent function. The third processing unit is a support unit with a supporter function.

The adviser unit generates and provides to respective main control systems information to be used at respective main control systems, based on the environmental information around the vehicle or information related to the driver. The agent unit generates and provides to respective main control systems information to be used at respective main control systems to cause the vehicle to realize a predetermined behavior. The supporter unit generates and provides to respective main control systems information to be used at respective main control systems based on the current dynamic state of the vehicle. At respective main control systems, determination is made as to whether or not such information input from the adviser unit, the agent unit and the supporter unit (information other than the request of the driver) is to be reflected in the motion control of the vehicle, and to what extent, if to be reflected. Furthermore, the control target is corrected, and/or information is transmitted among respective control units. Since each main control system operates autonomously, the actuator of the power train, the actuator of brake device and the actuator of steering device are controlled eventually at respective control units based on the eventual driving target, braking target and steering target calculated by the sensed manipulation information of the driver, information input from the adviser unit, agent unit and supporter unit, and information transmitted among respective main control systems.

Specifically, the adviser unit generates information representing the degree of risk with respect to the vehicle operation property based on the frictional resistance (μvalue) of the road on which the vehicle is running, the outdoor temperature and the like as the environmental information around the vehicle, and/or generates information representing the degree of risk with respect to the manipulation of the driver based on the fatigue level of the driver upon shooting a picture of the driver. Information representing the degree of risk is output to each main control system. This information representing the degree of risk is processed at the adviser unit so the information can be used at any of the main control systems. At each main control system, the process is carried out as to whether or not to reflect the information related to the input risk for the vehicle motion control, in addition to the request of the driver from the adviser unit, and to what extent the information is to be reflected, and the like.

Specifically, the agent unit generates information to implement an automatic cruise function for the automatic drive of vehicle. The information to implement the automatic cruise function is output to each main control system. At each main control system, the process is carried out as to whether or not to reflect the input information to implement the automatic cruise function, in addition to the request of the driver from the processing unit, and to what extent the information is to be reflected, and the like.

Further preferably, the supporter unit identifies the current dynamic state of the vehicle, and generates information to modify the target value at each main control system. The information to modify the target value is output to each main control system. At each main control system, the process is carried out as to whether or not to reflect the input information to modify the target value based on the dynamic state for the vehicle motion control, in addition to the request of the driver from the processing unit, and to what extent the information is to be reflected, and the like.

As shown in FIG. 2, the basic control units of main control system (1), main control system (2) and main control system (3), and the support unit of the adviser unit, agent unit, and supporter unit are all configured so as to operate autonomously. Main control system (1) is designated as the PT (Power Train) system. Main control system (2) is designated as the ECB (Electronic Controlled Brake) system. Main control system (3) is designated as the STR (Steering) system. A portion of the adviser unit and the portion of the agent unit are designated as the DSS (Driving Support System). A portion of the adviser unit, a portion of the agent unit, and a portion of the supporter unit are designated as the VDM (Vehicle Dynamics Management) system. Interruption control for intervention of control executed at main control system (1), main control system (2) and main control system (3) from the agent unit (automatic cruise function) is conducted in the control shown in FIG. 2.

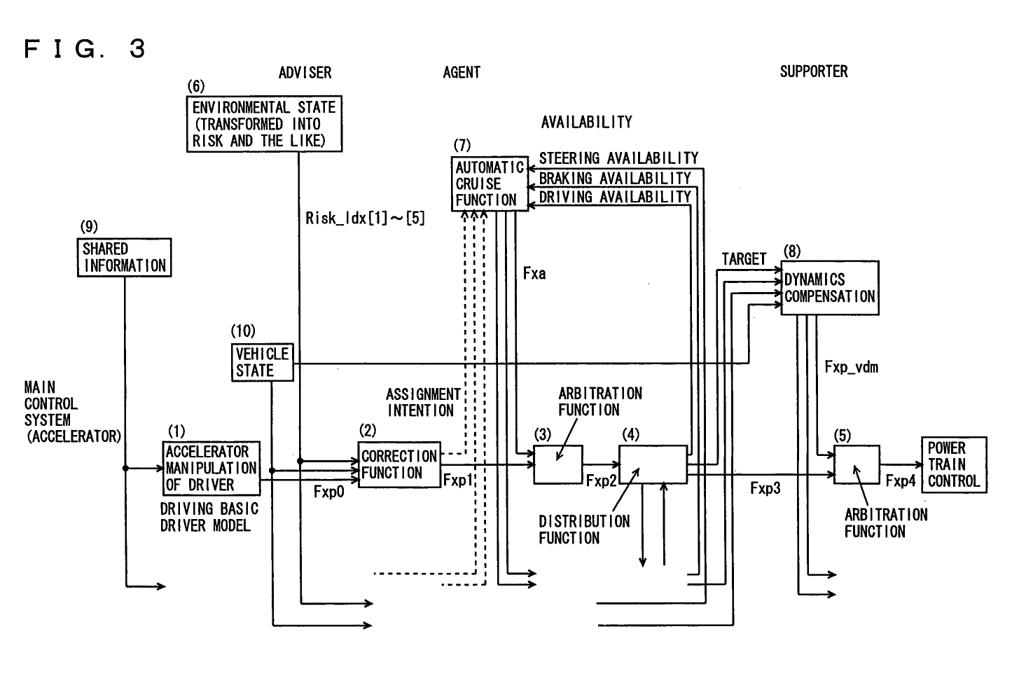

Main control system (1) (driving system control unit) will be described in further detail with reference to FIG. 3. Although the designation of the variable labels may differ in FIG. 3 and et seq., there is no essential difference thereby in the present invention. For example, the interface is designated as Gx*(acceleration) in FIG. 2 whereas the interface is designated as Fx (driving force) in FIG. 3 and et seq. This corresponds to F (force)=m (mass)×α (acceleration), where the vehicle mass (m) is not the subject of control, and is not envisaged of being variable. Therefore, there is no essential difference between Gx*(acceleration) of FIG. 2 and Fx (driving force) of FIG. 3 and et seq.

Main control system (1) that is the unit to control the driving system receives information such as the vehicle velocity, gear ratio of the transmission and the like identified as shared information (9). Using such information and the driving basic driver model, Fxp0 representing the target longitudinal direction acceleration is calculated as the output of the driving basic driver model. The calculated Fxp0 is corrected to Fxp1 by a correction functional unit (2) using environmental state (6) that is the risk degree information (index) as an abstraction of risk and the like, input from the adviser unit. Information representing the intention of assignment with respect to realizing an automatic cruise function is output from correction functional unit (2) to agent unit (7). Using Fxp1 corrected by correction functional unit (2) and information for implementation of automatic cruise functional unit (7), input from the agent unit, the information (Fxp1, Fxa) is arbitrated by arbitration functional unit (3) to Fxp2.

The dividing ratio of the driving torque and braking torque is calculated between main control system (1) that is the unit controlling the driving system and main control system (2) that is the unit driving the brake system. At main control system (1) corresponding to the driving unit side, Fxp3 of the driving system is calculated. FxB is output from distribution functional unit (4) to main control system (2), and the driving availability and target value are output to agent unit (7) and dynamic (8) that is the supporter unit, respectively.

At arbitration functional unit (5), the information is arbitrated to Fxp4 using Fxp3 output from distribution functional unit (4) and Fxp_vdm from dynamics compensation functional unit (8). Based on the arbitrated Fxp4, the power train is controlled.

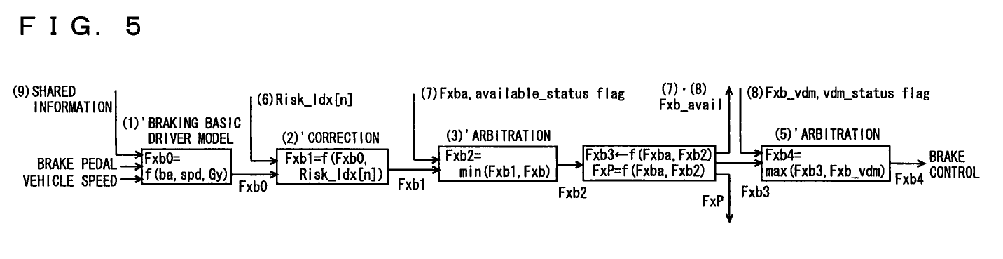

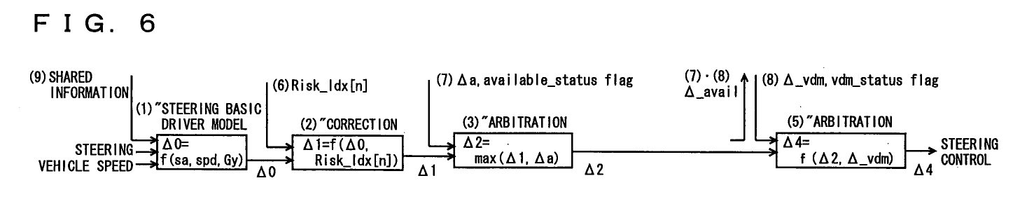

The elements shown in FIG. 3 are also present in main control system (2) and main control system (3). Since main control system (2) and main control system (3) will be described in further detail with reference to FIGS. 5-6, description on main control system (2) and main control system (3) based on drawings corresponding to main control system (1) of FIG. 3 will not be repeated.

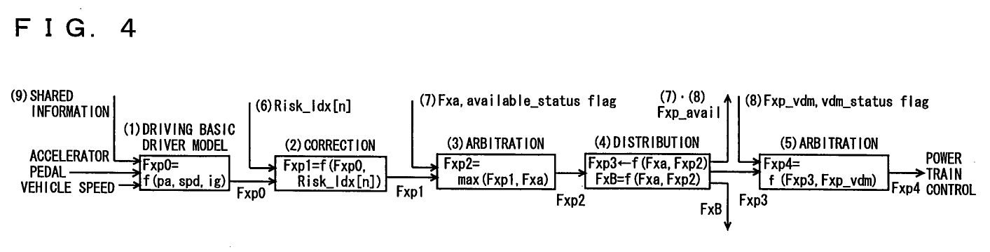

FIGS. 4-6 represent the control configuration of main control system (1), main control system (2) and main control system (3).

FIG. 4 shows a control configuration of main control system (1). Main control system (1) that covers control of the driving system is adapted by the procedures set forth below.

At driving basic driver model (1), the basic drive driver model output (Fxp0) is calculated based on HMI (Human Machine Interface) input information such as the accelerator pedal opening angle (pa), vehicle speed (spd) and gear ratio (ig) of the transmission that are shared information (9), and the like. The equation at this stage is represented by Fxp0=f (pa, spd, ig), using function f.

At correction functional unit (2), Fxp0 is corrected to output Fxp1 based on Risk_Idx [n] that is the environmental information (6) from the advisor unit (for example, information transformed into the concept of risk or the like). The equation at this stage is represented by Fxp1=f(Fxp0, Risk_Idx [n]), using function f Specifically, it is calculated by, for example, Fxp11=Fxp0×Risk_Idx [n]. The degree of risk is input from the advisor unit such as Risk_Idx [1]=0.8, Risk_Idx [2]=0.6, and Risk_Idx [3]=0.5.

Additionally, Fxp12 is calculated, which is a corrected version of Fxp0, based on information that is transformed into the concept of stability and the like from the vehicle state (10). The equation at this stage is represented by, for example, Fxp12=Fxp0×Stable_Idx [n]. The stability is input such as Stable_Idx [1]=0.8, Stable_Idx [2]=0.6, and Stable_Idx [3]=0.5.

A smaller value of these Fxp11 and Fxp12 may be selected to be output as Fxp1.

In this correction functional unit (2), assignment intention information can be output to automatic cruise functional unit (7) that is an agent function when the driver depresses the cruise control switch. In the case where the accelerator pedal is a reaction force controllable type here, the automatic cruise intention of the driver is identified based on the driver's manipulation with respect to the accelerator pedal to output assignment intention information to automatic cruise functional unit (7).

At arbitration functional unit (3), arbitration between Fxp1 output from correction functional unit (2) and Fxa output from automatic cruise functional unit (7) of the agent unit is executed to output Fxp2 to distribution unit (4). When accompanied with additional information (flag, available_status flag) indicative of output Fxa from automatic cruise functional unit (7) being valid, the arbitration function selects Fxa that is the output from automatic cruise functional unit (7) with highest priority to calculate Fxp2. In other cases, Fxp1 that is the output from correction functional unit (2) may be selected to calculate Fxp2, or Fxp1 output from correction function unit (2) may have Fxa reflected at a predetermined degree of reflection to calculate Fxp2. The equation at this stage is represented by Fxp2=max (Fxp1, Fxa), for example, using a function “max” that selects the larger value.

At distribution functional unit (4), distribution operation is mainly effected between main control system (1) that is the driving system control unit and main control system (2) that is the brake system control unit. Distribution functional unit (4) functions to output Fxp3 to arbitration functional unit (5) for the distribution towards the driving system that is the calculated result, and outputs FxB to main control system (2) for the distribution towards the brake system that is the calculated result. Further, driving availability Fxp_avail identified as the information of the driving power source that can be output from the power train which is the subject of control of main control system (1) is provided to automatic cruise functional unit (7) identified as the agent unit and dynamics compensation functional unit (8) identified as the supporter unit. The equation at this stage is represented by Fxp3←f (Fxa, Fxp2), FxB=f (Fxa, Fxp2), using function f.

At arbitration functional unit (5), arbitration is executed between Fxp3 output from distribution functional unit (4) and Fxp_vdm output from dynamics compensation functional unit (8) to output Fxp4 to the power train controller. When accompanied with additional information (flag, vdm_status flag) indicative of Fxp_vdm output from dynamics compensation functional unit (8) being valid, the arbitration function selects Fxp_vdm that is the output from dynamics compensation functional unit (8) with highest priority to calculate Fxp4. In other cases, Fxp3 that is the output from distribution functional unit (4) can be selected to calculate Fxp4, or Fxp3 output from distribution functional unit (4) may have Fxp_vdm reflected by a predetermined degree of reflection to calculate Fxp4. The equation at this stage is represented by, for example, Fxp4=f (Fxp3, Fxp_vdm).

FIG. 5 represents the control configuration of main control system (2). Main control system (2) covering the control of the brake system is adapted by the procedure set forth below.

At the brake basic driver model (1)′, the basic braking driver model output (Fxp0) is calculated based on the HMI input information such as the brake pedal depression (ba), as well as vehicle speed (spd), that is the shared information (9), the lateral G acting on the vehicle (Gy), and the like. The equation at this stage is represented by Fxb0=f (pa, spd, Gy), using function f.

At correction function unit (2)′, Fxb0 is corrected to output Fxb1 based on Risk_Idx [n] that is the environmental information (6) from the advisor unit (for example, information transformed into the concept of risk and the like). The equation at this stage is represented by Fxb1=f (Fxb0, Risk_Idx [n]), using function f.

More specifically, it is calculated by, for example, Fxb11=Fxb0×Risk_Idx [n]. The degree of risk is input from the advisor unit such as Risk_Idx [1]=0.8, Risk_Idx [2]=0.6, and Risk_Idx [3]=0.5.

Further, Fxb12 that is a corrected version of Fxb0 is calculated, based on information transformed into the concept of stability and the like from the vehicle state (10). It is calculated by, for example, Fxb12=Fxb0×Stable_Idx [n]. For example, Stable_Idx [1]=0.8, Stable_Idx [2]=0.6, and Stable_Idx [3]=0.5 are input.

The larger of these Fxb11 and Fxb12 may be selected to be output as Fxb1. Specifically, the output may be corrected in accordance with the distance from the preceding running vehicle sensed by a millimeter wave radar, the distance to the next corner sensed by the navigation device, or the like.

At arbitration functional unit (3)′, arbitration is executed between Fxb1 output from correction functional unit (2)′ and Fxba output from automatic cruise functional unit (7) that is the agent unit to output Fxb2 to distribution unit (4)′. When accompanied with additional information (flag, available_status flag) indicative of Fxba output from automatic cruise functional unit (7) being valid, the arbitration function selects Fxba that is the output from automatic cruise functional unit (7) with highest priority to calculate Fxb2. In other cases, Fxb1 that is the output from correction functional unit (2)′ may be selected to calculate Fxb2, or Fxb1 that is the output from correction functional unit (2)′ may have Fxba reflected by a predetermined degree of reflection to calculate Fxb2. The equation at this stage is represented by, for example, Fxb2=max (Fxb 1, Fxba), using a function “max” that selects the larger value.

At distribution functional unit (4)′, distribution operation is conducted between main control system (1) that is the driving system control unit and main control system (2) that is the brake system control unit. Functional distribution unit (4)′ corresponds to distribution functional unit (4) of main control system (1). Distribution functional unit (4)′ outputs Fxb3 to arbitration functional unit (5)′ for distribution towards the brake system that is the calculated result, and outputs FxP to main control system (1) for distribution towards the driving system that is the calculated result. Further, brake availability Fxb_avail identified as information that can be output from the brake that is the subject of control of main control system (2) is provided to automatic cruise functional unit (7) identified as the agent unit and dynamics compensation functional unit (8) identified as the supporter unit. The equation at this stage is represented by Fxb3 ←f (Fxba, Fxb2), FxP=f (Fxba, Fxb2), using function f.

Arbitration functional unit (5)′ executes arbitration between Fxb3 output from distribution functional unit (4)′ and Fxb_vdm output from dynamics compensation functional unit (8) that is the support unit to output Fxb4 to the brake controller. When accompanied with additional information (flag, vdm_status flag) indicative of Fxb_vdm output from dynamics compensation functional unit (8) being valid, the arbitration function selects Fxb_vdm that is the output from dynamics compensation functional unit (8) with highest priority to calculate Fxb4. In other cases, Fxb3 that is the output from distribution functional unit (4)′ may be selected to calculate Fxb4, or Fxb3 output from distribution functional unit (4)′ may have Fxb_vdm reflected by a predetermined degree of reflection to calculate Fxb4. The equation at this stage is represented by, for example, Fxb4=max (Fxb3, Fxb_vdm), using a function “max” that selects the larger value.

FIG. 6 shows a control configuration of main control system (3). Main control system (3) covering control of the steering system is adapted to control by the procedure set forth below.

At steering basic driver model (1)″, basic steering driver model output (Δ0) is calculated based on HMI input information such as the steering angle (sa), vehicle speed (spd) that is shared information (9), lateral G acting on the vehicle (Gy), and the like. The equation at this stage is represented by Δ0=f (sa, spd, Gy), using function f.

At correction functional unit (2)″, Δ0 is corrected to output Δ1 based on Risk_Idx [n] that is environmental information (6) from the adviser unit (for example, information transformed into the concept of risk, and the like). The equation at this stage is represented by Δ1=f (Δ0, Risk_Idx [n]), using function f.

Specifically, it is calculated by Δ11=Δ0×Risk_Idx [n]. The degree of risk is input from the adviser unit such as Risk_Idx [n]=0.8, Risk_Idx [2]=0.6, and Risk_Idx [3]=0.5.

Further, Δ12 that is a corrected version of Δ0 is calculated based on information transformed into the concept of stability and the like from the vehicle state (10). The equation at this stage is represented by Δ12=Δ0×Stable_Idx [n]. For example, Stable_Idx [1]=0.8, Stable_Idx [2]=0.6, and Stable_Idx [3]=0.5 are input.

The smaller of these Δ11 and Δ12 may be selected to be output as Δ1.

At correction functional unit (2)″, assignment intention information to automatic cruise functional unit (7) that is the agent function can be output when the driver has depressed the lane keep assist switch. Furthermore, the output may be corrected in accordance with an external disturbance such as the side wind at correction functional unit (2)″.

At arbitration functional unit (3)″, arbitration is executed between Δ1 output from correction functional unit (2)″ and Δa output from automatic cruise functional unit (7) that is the agent unit to output Δ2 to arbitration unit (5)″. When accompanied with additional information (flag, available_status flag) indicative of Δa that is the output from automatic cruise functional unit (7) being valid, the arbitration function selects Aa that is the output from automatic cruise functional unit (7) with the highest priority to calculate Δ2. In other cases, Δ1 that is the output from correction functional unit (2)″ may be selected to calculate Δ2, or Δ1 that is the output from correction functional unit (2)″ may have Aa reflected by a predetermined degree of reflection to calculate Δ2. The equation at this stage is represented by, for example, Δ2=f (Δ1, Δa).

At arbitration functional unit (5)″, arbitration is executed between Δ2 output from arbitration functional unit (3)″ and A_vdm output from dynamics compensation function unit (8) that is the supporter unit to provide Δ4 to the steering controller. When accompanied with additional information (flag_vdm_status flag) indicative of Δ_vdm output from dynamics compensation functional unit (8) being valid, the arbitration function selects Δ_vdm that is the output from dynamics compensation functional unit (8) with highest priority to calculate Δ4. In other cases, Δ2 may be selected that is the output from arbitration functional unit (3)″ to calculate Δ4, or Δ2 that is the output from arbitration functional unit (3)″ may have Δ_vdm reflected by a predetermined degree of reflection to calculate Δ4. The equation at this stage is represented by, for example, Δ4=max (Δ2, Δ_vdm), using a function “max” that selects the larger value.

The operation of a vehicle incorporating the integrated control system set forth above will be described hereinafter.

During driving, the driver manipulates accelerator pedal 200, brake pedal 580 and steering wheel 440 to control the driving system control unit corresponding to the “running” operation that is the basic operation of a vehicle, the brake system control unit corresponding to the “stop” operation, and the steering system control unit corresponding to a “turning” operation, based on information obtained by the driver through his/her own sensory organs (mainly through sight). Basically, the driver controls the vehicle through HMI input therefrom. There may also be the case where the driver manipulates the shift lever of the automatic transmission to modify the gear ratio of transmission 240 in an auxiliary manner.

During the drive of a vehicle, various environmental information around the vehicle is sensed by various devices incorporated in the vehicle, in addition to the information obtained by the driver through his/her own sensory organs. The information includes, by way of example, the distance from the vehicle running ahead, sensed by a millimeter wave radar, the current vehicle position and the road state ahead (corner, traffic jam, and the like) sensed by the navigation device, the road inclination state sensed by a G sensor (level road, up-climbing road, down-climbing road), the outdoor temperature of vehicle sensed by an outdoor temperature sensor, local weather information of the current running site received from a navigation device equipped with a receiver, the road resistance coefficient (low μ road state and the like by road surface freezing state), the running state of the vehicle ahead sensed by a blind corner sensor, a lane-keep state sensed based upon an image-processed picture taken by an outdoor camera, the driving state of the driver sensed based upon an image-processed picture taken by an indoor camera (driver posture, wakeful state, nod-off state), the dosing state of a driver sensed by sensing and analyzing the grip of the driver's hand by a pressure sensor provided at the steering wheel, and the like. These information are divided into environmental information around the vehicle, and information about the driver himself/herself. It is to be noted that both information are not sensed through the sensory organs of the driver.

Furthermore, the vehicle dynamic state is sensed by a sensor provided at the vehicle. The information includes, by way of example, wheel speed Vw, vehicle speed in the longitudinal direction Vx, longitudinal acceleration Gx, lateral acceleration Gy, yaw rate y, and the like.

The present vehicle incorporates a cruise control system and a lane-keep assist system as the driving support system to support the driver's drive. These systems are under control of the agent unit. It is expected that a further development of the agent unit will lead to implementation of a complete automatic cruising operation, exceeding the pseudo automatic cruising. The integrated control system of the present embodiment is applicable to such cases. Particularly, implementation of such an automatic cruising system is allowed by just modifying the automatic cruise function of the agent unit to an automatic cruise function of a higher level without modifying the driving system control unit corresponding to main control system (1), the brake system control unit corresponding to main control system (2), the steering system control unit corresponding to main control system (3), the adviser unit, and the supporter unit.

Consider a case where there is a corner ahead in the currently-running road during driving. This corner cannot be identified by the eye sight of the driver, and the driver is not aware of such a corner. The adviser unit of the vehicle senses the presence of such a corner based on information from a navigation device.

When the driver steps on accelerator pedal 200 for acceleration in the case set forth above, the driver will depress brake pedal 580 subsequently to reduce the speed of the vehicle at the corner. At main control system (1), the basic drive driver model output Fxp0 is calculated by Fxp0=f (pa, spd, ig), based on the accelerator pedal opening angle (pa), vehicle speed (spd), gear ratio of the transmission (ig), and the like. Conventionally, a large request driving torque value will be calculated based on this FXP0 to cause opening of the throttle valve of engine 140, and/or reducing the gear ratio of transmission 240 to cause vehicle acceleration. In the present invention, the adviser unit calculates the degree of risk Risk_Idx [n] based on the presence of the corner ahead and outputs this information to correction functional unit (2). Correction functional unit (2) performs correction such that acceleration is not exhibited as the driver will expect from his/her depression on accelerator pedal 200.

When the supporter unit senses that the road surface is freezing and there is a possibility of slipping sideways by the vehicle longitudinal acceleration at this stage, Stable_Idx [n] that is the degree of risk related to stability is calculated and output to correction functional unit (2). Thus, correction functional unit (2) performs correction such that acceleration is not exhibited as the driver will expect from his/her depression on accelerator pedal 200.

When slippage of the vehicle is sensed, the supporter unit outputs to arbitration functional unit (5) a signal that will reduce the driving torque. In this case, Fxp_vdm from the supporter unit is employed with priority such that the power train is controlled to suppress further slippage of the vehicle. Therefore, even if the driver steps on accelerator pedal 200 greatly, arbitration is established such that the acceleration is not exhibited as the driver will expect from his/her depression on accelerator pedal 200.

Such a vehicle integrated control system will be described in further detail hereinafter.

### FIRST SPECIFIC EXAMPLE

The first specific example is directed to control of giving priority to the manual manipulation of the driver over the control target from the adviser unit, agent unit, and supporter unit in order to control the vehicle giving priority to manual manipulation of the driver. The vehicle integrated control system set forth above is characterized in how the level of manual manipulation by the driver is reflected in driving system control.

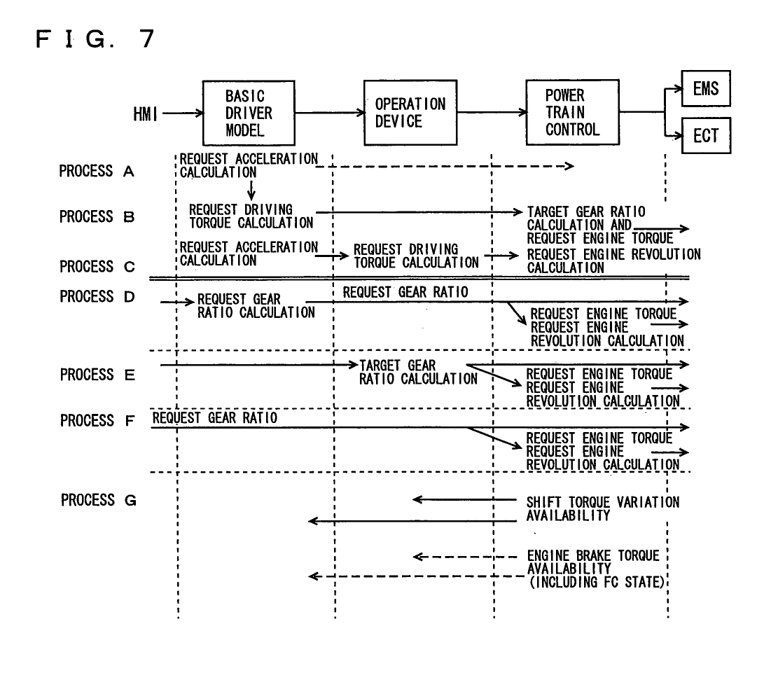

FIG. 7 represents the operation of the control system in the implementation of such control. FIG. 7 corresponds to main control system (1) (accelerator) of FIG. 2.

In a normal operation, the request acceleration is calculated using a basic driver model based on the accelerator pedal manipulation of the driver (process A). The request driving torque to realize the request acceleration is calculated. Based on the request driving torque and vehicle speed, the target gear ratio and target engine value (request engine torque, request engine revolution) are calculated (process B or C). At this stage, the request driving torque and target gear ratio may be corrected based on the control target from the adviser unit, agent unit, and supporter unit.

These target gear ratio and target engine value are provided to the EMS (Engine Management System) and ECT (Electronically Controlled Automatic Transmission) for control of engine 140 and transmission 240.

In the case where the vehicle is controlled in an integrated manner based on such control, the request gear ratio is input by setting the gear position through the manual shift lever in accordance with the HMI (as a result, request gear ratio is input), or through the steering switch of the sequential shift (process D). In this state of affairs, power train control is effected using the manual gear ratio of the driver with priority over the target gear ratio calculated at processes A-C. Based on the request gear ratio through the manual shift request applied by the driver, the request engine revolution and request engine torque are calculated. Lower and upper limits or guard is provided in the request gear ratio applied manually by the driver from the standpoint of limitation in the vehicle motion performance. This is directed to rejecting any manual manipulation exceeding the limit of behavior of the vehicle.

With respect to this manual shift instruction, the request driving torque can accommodate the two types of modification as the value calculated by processes A-C, i.e. modification of the ECT gear ratio, and modification of the request driving torque and ECT gear ratio. In the case where the request driving torque is to be also modified, calculation of the request driving torque is continuously output to prepare for the return to normal control. In other words, when the driver of the vehicle having the request driving torque modified based on the manual shift of the transmission returns to, for example, the D position, the vehicle can quickly return to normal control since the driving request torque has been calculated.

In the case where the request driving force is not modified, the request engine revolution and request engine torque can be calculated from the request gear ratio, as in process E or F. Furthermore, the shift torque variation availability and engine brake torque availability are returned to the basic driver model, as in process G. By returning the availability from the lower hierarchy to the upper hierarchy, the availability can be used as information to generally identify the vehicle motion state expected when the driver's manual manipulation is to be given priority. It is to be noted that the driver's manual manipulation is given highest priority.

Torque variation occurs during gear shifting in the shift torque availability when the gear ratio of transmission 240 is to be changed by the manual gear shift manipulation of the driver. The shift torque availability can be calculated using a model of transmission 240 based on a function such as the shift torque availability=f (current request driving torque, post-shift request driving torque, current gear ratio, future gear ratio, vehicle speed). Additionally, the shift torque availability may be adapted to be calculated using a map instead of a function.

The engine brake torque availability is calculated such that the engine torque for each vehicle speed under a complete throttle closed state is included in the shift torque variation availability, using two maps of a fuel injection state and fuel cut state. Calculation of the request acceleration and request torque is conducted using such availability.

In the vehicle integrated control system of the present invention, the vehicle can be controlled properly corresponding to the driver's manual request.

The gear ratio of the above-described specific example is only a way of example, and the request by the driver is not limited to gear ratio. The vehicle can be controlled properly corresponding to the driver's manual request even in the case where the vehicle is adapted to allow input of the request acceleration and request driving torque manually by the driver.

### SECOND SPECIFIC EXAMPLE

The second specific example is directed to correcting a parameter in the vehicle integrated control system based on the driver's manual manipulation. The vehicle control system is characterized in how the level of manual manipulation by the driver is reflected in the driving system control.

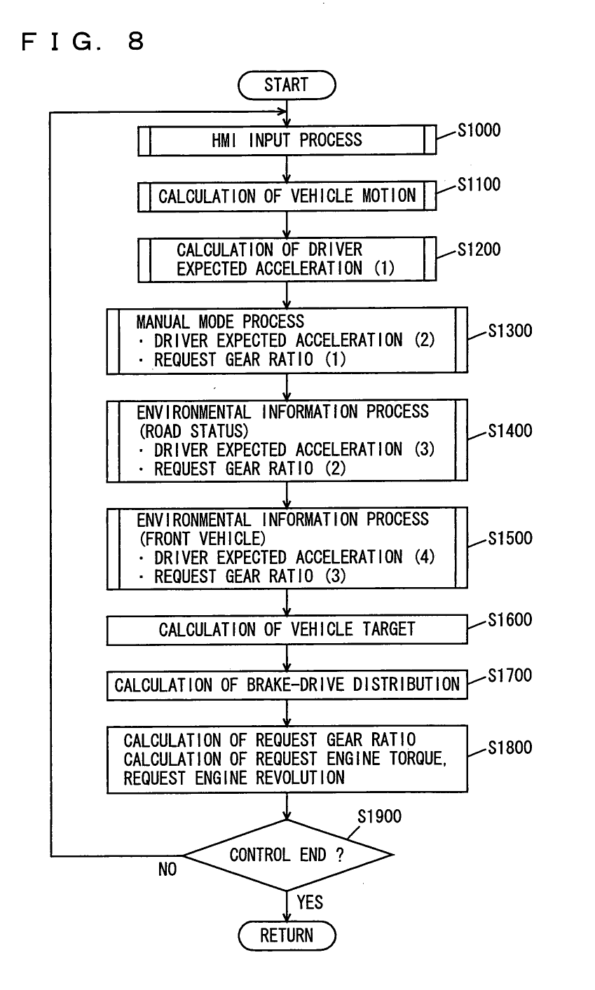

A control configuration of a program executed by the ECU of the main control system (accelerator) of the vehicle integrated control device of the present example will be described hereinafter with reference to FIG. 8.

At step (step abbreviated as “S” hereinafter) 1000, the ECU executes an HMI input process. The process of this S1000 will be described in detail afterwards.

At S1100, the ECU calculates the vehicle motion. The process of this S1100 will be described in detail afterwards. At S1200, the ECU calculates the driver expected acceleration (1). The process at this S1200 will be described in detail afterwards. As S1300, the ECU executes a manual mode process. As a result of the manual mode process, driver expected acceleration (2) and request gear ratio (1) are calculated. The process of this S1300 will be described in detail afterwards.

At S1400, the ECU executes an environmental information process (road status). As a result of this environmental information process (road status), driver expected acceleration (3) and request gear ratio (2) are calculated. The process of this S1400 will be described in detail afterwards.

At S1500, the ECU executes an environmental information process (front vehicle). By this environmental information process (front vehicle), driver expected acceleration (4) and request gear ratio (3) are calculated. The process of this S1500 will be described in detail afterwards.

At S1600, the ECU calculates the vehicle target. At this stage, the vehicle motion target value is calculated based on the driver's request.

At S1700, the ECU executes the brake-drive distribution calculation. The request driving torque is calculated by this brake-drive distribution calculation.

At S1800, the ECU calculates the request gear ratio as well as the request engine torque and request engine revolution. At this process of S1800, the request gear ratio is calculated taking into account the request gear ratio (1) calculated at S1300, the request gear ratio (2) calculated at S1400, and the request gear ratio (3) calculated at S1500.

At S1900, the ECU determines whether to terminate such control or not. This determination is made based on an input signal through a manual mode switch applied to the ECU. When the control is to be terminated (YES at S1900), the process ends, otherwise (NO at S1900), the process returns to S1000.

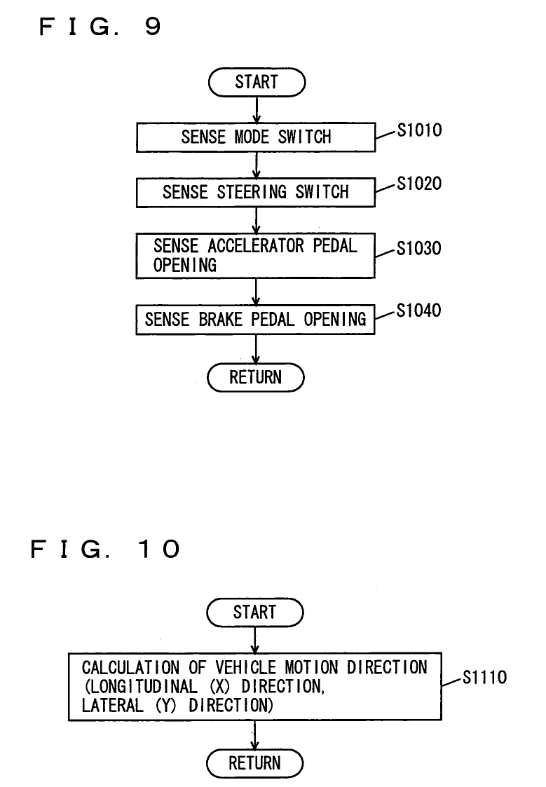

The details of the process of S1000 of FIG. 8 will be described hereinafter with reference to FIG. 9.

At S1010, the ECU senses the mode switch. This mode switch can be implemented in hardware or software, allowing selection of, for example, general sports mode, general economic running mode, and the like. This mode switch is provided at a position that can be operated by the driver.

At S1020, the ECU senses the state of the steering switch. This steering switch is directed to, for example, upshifting or downshifting the gear of transmission 240 with sequential shift. At S1030, the ECU senses the opening of the accelerator pedal. At S1040, the ECU senses the opening of the brake pedal.

By the HMI input process shown in FIG. 9, the state of mode switch, steering switch, accelerator pedal, and brake pedal can be sensed.

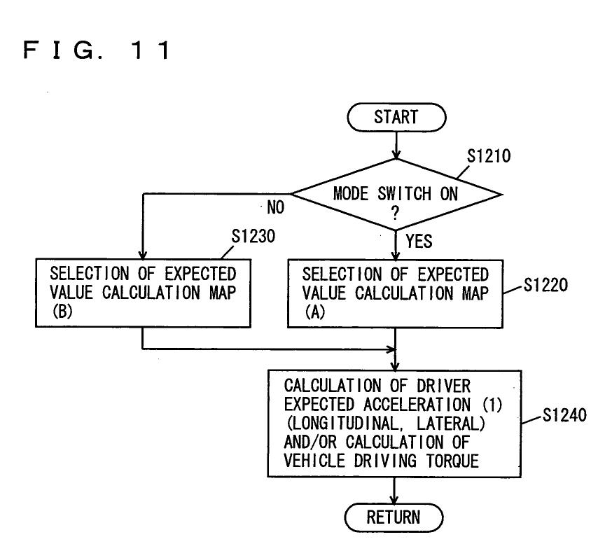

The process of S1100 of FIG. 8 will be described in detail with reference to FIG. 10.

At S1100, the ECU calculates the motion direction of the vehicle. The motion direction is divided in the longitudinal (X) direction and lateral (Y) direction. Specifically, the longitudinal (X) motion of the vehicle is represented by acceleration and deceleration. The lateral (Y) motion of the vehicle corresponds to the motion of the vehicle in the right and left directions caused by steering. Such motion directions are calculated as longitudinal acceleration Gx and lateral acceleration Gy.

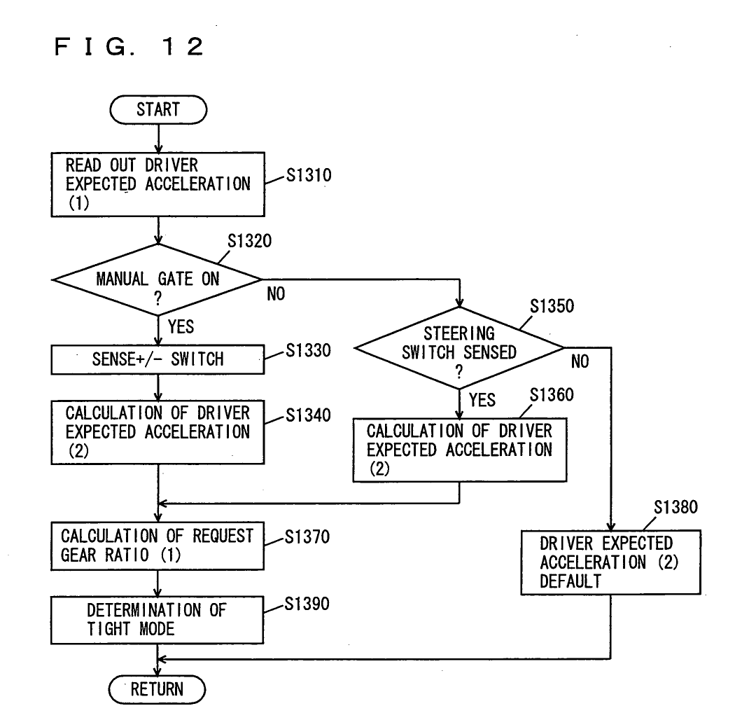

The process of S1200 of FIG. 8 will be described in detail with reference to FIG. 11.

At S1210, the ECU determines whether the mode switch is ON or not. When the mode switch is ON (YES at S1210), the process proceeds to S1220, otherwise (NO at S1210), the process proceeds to S1230. An ON status of the mode switch means that the driver intends to take direct control of engine 140, transmission 240 and brake 560.

At S1220, the ECU selects an expected value calculation map (A). At S1230, the ECU selects an expected value calculation map (B). The expected value calculation map (A) and expected value calculation map (B) are stored in a memory in the ECU. These expected value calculation maps have different absolute values and inclinations for calculation of the expected value. For example, the relationship between the accelerator pedal opening and the driver's expected acceleration is stored as a map.

At S1240, the ECU calculates the driver expected acceleration (1) (longitudinal, lateral) and/or vehicle driving torque.

In the calculation of driver expected acceleration (1), the acceleration is generated based on the applied general accelerator pedal manipulation. As an alternative to this map, the acceleration can be represented by an equation such as driver expected acceleration (1)=f (accelerator pedal manipulation amount, vehicle speed, gear ratio)×f (accelerator pedal manipulation speed, gear ratio) and the like.

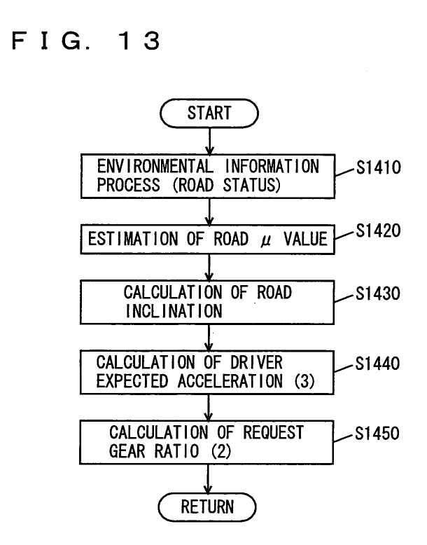

The process of S1300 of FIG. 8 will be described in detail with reference to FIG. 12.

At S1310, the ECU reads out driver expected acceleration (1), which is the value calculated at the preceding S1240.

At S1320, the ECU determines whether the manual gate of the floor shift is ON or not. When the manual gate is ON (YES at S1320), the process proceeds to S1330, otherwise (NO at S1320), the process proceeds to S1350.

At S1330, the ECU senses the +/−switch of the manual gate. At S1340, the ECU calculates driver expected acceleration (2). Specifically, the driver expected acceleration (2) is calculated depending upon whether the driver has requested upshift or downshift at the sequential shift provided at the manual gate. At this stage, driver expected acceleration (1) read out at S1310 is corrected to driver expected acceleration (2). Following this S1340, the process proceeds to S1370.

At S1350, the ECU senses whether the steering switch has been operated or not. The steering switch is provided at the steering to select upshift and downshift corresponding to the sequential shift. When operation of the steering switch is sensed (YES at S1350), the process proceeds to S1360, otherwise (NO at S1350), the process proceeds to S1380.

At S1360, the ECU calculates driver expected acceleration (2).

At S1370, the ECU calculates request gear ratio (1). The operation to calculate the request gear ratio is maintained in the gear ratio or shift range determined through switch input, likewise the conventionally implemented manual shift.

At S1380, the ECU sets the driver expected acceleration (2) to the default value (normally 0).

At S1390, the ECU determines entry of a tight mode. Specifically, the tight mode is determined depending upon whether the lock up mechanism of torque converter 220 is ON or OFF. When the lock up mechanism is ON, engine 140 is directly coupled with transmission 240, corresponding to a tight feeling. When the lock up mechanism is OFF, engine 140 is not directly coupled with transmission 240 (fluid coupling), corresponding to a loose feeling. When determination is made of a tight mode, the shift tight feeling and/or the tight feeling by an ON state of the lock up clutch of torque converter 220 is processed at the power train side, or a physical target value thereof is transmitted to the power train side. The tight mode determination is based on the accelerator pedal stroke, vehicle speed, gear ratio, and the like, which is a level of manipulation by the driver.

The flow chart of FIG. 12 corresponds to a manual manipulation of the driver. It is to be noted that the driver expected acceleration (1) is constantly calculated regardless of the presence of manual manipulation. By constantly calculating the driver expected acceleration independent of the manual manipulation of the driver, the vehicle can immediately return to the former state when the manual manipulation state ends.

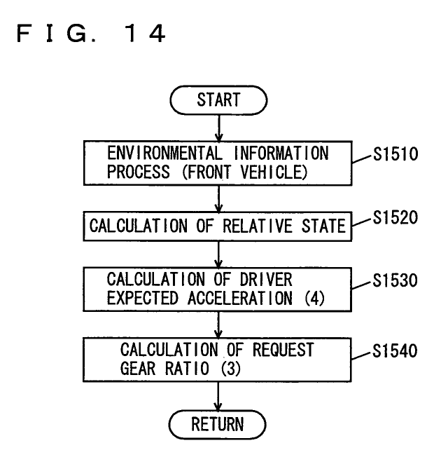

The process of S1400 of FIG. 8 will be described in detail with reference to FIG. 13.

At S1410, the ECU executes an environmental information process (road status). The road configuration is detected by a navigation device. The status of the road on which the vehicle is running is sensed by an on-vehicle camera. The temperature, amount of rain, and the like are identified through various sensors. At S1420, the ECU estimates the >value that is the frictional resistance of the road.

At S1430, the ECU calculates the road inclination. At S1440, the ECU calculates driver expected acceleration (3). Calculation is carried out such that, for example, deceleration increases when the vehicle is coming to a corner based on information from the navigation device. At this stage, a multiplier factor is preferably used. This multiplier factor is applied through a map with the curvature of the corner and/or road inclination as parameters. When it is estimated that the μ value corresponding to the frictional resistance of the road is low, a large multiplier factor is taken-(reduce deceleration) to suppress slippage of the vehicle caused by excessive engine brake torque.

At S1450, the ECU calculates request gear ratio (2) from driver expected acceleration (3) calculated at S1440.

The process of S1500 of FIG. 8 will be described in detail with reference to FIG. 14.

At S1510, the ECU executes an environmental information process (front vehicle). Various information are processed with the vehicle running ahead sensed by an on-vehicle camera, millimeter wave radar, or the like as the sensing subject.

At S1520, the ECU calculates the relative state between its own vehicle and the vehicle ahead. In this relative state calculation, a factor value is calculated obtained from a two dimensional map formed of the vehicle distance information from the vehicle ahead and the vehicle speed.

At S1530, the ECU calculates driver expected acceleration (4). At this stage, the multiplier factor obtained from the secondary map calculated at S1520 is used in the correction calculation. At S1540, the ECU calculates driver request gear ratio (3) based on the driver expected acceleration (4) calculated at S1530.

In accordance with the present example, the driver expected acceleration and request gear ratio are calculated in accordance with the basic manipulation of the driver when there is no input from the driver's manual manipulation device or when there is no output from the high functional units such as the advisory unit, agent unit or supporter unit. This value eventually becomes the brake-drive parameter or the parameter representing the gear ratio of the transmission. When in a manual mode operation by the driver (for example, manual gate selection through the gate type shift lever, or input through the switch on the steering or the paddle switch at the rear of the steering), the driver expected value is processed or recalculated. When the driver selects the mode switch, the driver expected value is processed or recalculated. Particularly in the case where there is an input from the driver's manual manipulation device and the vehicle environmental information (road status, front vehicle information) and the like is sensed, the driver expected value is processed or recalculated.

Thus, the vehicle integrated control system of the present embodiment operates as follows: at main control system (1) identified as the driving system control unit, accelerator pedal manipulation that is a request of a driver is sensed, and a control target of the driving system corresponding to the accelerator pedal manipulation is generated using a driving basic driver model, whereby the power train that is a drive actuator is controlled. At main control system (2) identified as the brake system control unit, brake pedal manipulation that is a request of the driver is sensed, and a control target of the brake system corresponding to the brake pedal manipulation is generated using a brake basic driver model, whereby the brake device that is the braking actuator is controlled. At main control system (3) identified as the steering system control unit, steering manipulation that is a request of the driver is sensed, and a control target of the steering system corresponding to the steering manipulation is generated using a steering basic driver model, whereby the steering device that is an actuator is controlled. These control units operate autonomously.

In addition to the driving system control unit, brake system control unit, and steering system control unit operating autonomously, there are further provided an adviser unit, an agent unit, and a supporter unit. The adviser unit generates and provides to respective control units information to be used at respective control units based on environmental information around the vehicle or information related to the driver. The adviser unit processes information representing the degree of risk with respect to operation characteristics of the vehicle based on the frictional resistance of the running road, outer temperature and the like as environmental information around the vehicle, and/or information representing the degree of risk with respect to the manipulation of a driver based on the fatigue level of the driver upon shooting a picture of the driver so as to be shared among respective control units. The agent unit generates and provides to respective control units information to be used at respective control units to cause the vehicle to implement a predetermined behavior. The agent unit generates information to implement an automatic cruise functions for automatic cruising of vehicle. Information to implement the automatic cruise function is output to respective control units. The supporter unit generates and provides to respective control units information to be used at respective control unit based on the current dynamic state of the vehicle. The supporter unit identifies the current dynamic state of the vehicle to generate information required to modify the target value at respective control units.

At respective control units, arbitration processing is conducted as to whether information output from the adviser unit, agent unit and supporter unit is to be reflected in the motion control of the vehicle, and if to be reflected, the degree of reflection thereof. These control unit, adviser unit, agent unit and supporter unit operate autonomously. Eventually at respective control units, the power train, brake device, and steering device are controlled based on the eventual driving target, braking target, and steering target calculated by information input from the adviser unit, agent unit and supporter unit, as well as information communicated among respective control units.

Thus, the driving system control unit corresponding to a “running” operation that is the basic operation of the vehicle, the brake system control unit corresponding to a “stop” operation, and the steering system control unit corresponding to a “turning” operation are provided operable in a manner independent of each other. With respect to these control units, the adviser unit, agent unit and supporter unit are provided, that can generate and output to respective control units information related to the risk and stability with respect to environmental information around the vehicle and information related to the driver, information to implement automatic cruise function for automatic cruising of the vehicle, and information required to modify the target value of respective control units to these control units. Therefore, a vehicle integrated control system that can readily accommodate automatic cruising control of high level can be provided.

By calculating the driver expected acceleration and the request gear ratio based on the expected acceleration in accordance with a request by manual manipulation of the driver, behavior of the vehicle based on the driver's manual manipulation can be realized.

With the driver's manipulation given highest priority, control using signals from the driving support units of the adviser unit, agent unit and supporter unit will not be conducted when the flag from these driving supports units are reset.

Although the present invention has been described and illustrated in detail, it is clearly understood that the same is by way of illustration and example only and is not to be taken by way of limitation, the spirit and scope of the present invention being limited only by the terms of the appended claims.

1. A vehicle integrated control system comprises a plurality of control units operating autonomously for controlling a running state of the vehicle based on a manipulation request,
wherein each control unit comprises
a sensing unit for sensing a request of a driver, and
a controller for controlling said vehicle by generating a control target based on a request, and manipulating an actuator set in correspondence with each unit, using said control target,
said system further comprising
a processing unit generating information to be used to accommodate a direct request towards said actuator by said driver, said information being priority information used in priority over a control target generated at said controller, and providing the generated information to each said control unit.

2. The vehicle integrated control system according to claim 1, wherein said processing unit includes a generation unit generating said priority information based on environmental information around said vehicle and said direct request.

3. The vehicle integrated control system according to claim 2, wherein said environmental information includes information related to a road on which said vehicle runs.

4. The vehicle integrated control system according to claim 2, wherein said environmental information includes information related to another vehicle in a neighborhood of said vehicle.

5. The vehicle integrated control system according to claim 1, wherein each said controller generates a control target based on said request even when the vehicle is under integrated control with said priority information used at each control unit.

6. A vehicle integrated control system comprises a plurality of control units operating autonomously for controlling a running state of the vehicle based on a manipulation request,
wherein each control unit comprises
sensing means for sensing a request of a driver, and
controller means for controlling said vehicle by generating a control target based on a request, and manipulating an actuator set in correspondence with each unit, using said control target,
said system further comprising
a processing unit generating information to be used to accommodate a direct request towards said actuator by said driver, said information being priority information used in priority over a control target generated at said controller means, and providing the generated information to each said control unit.

7. The vehicle integrated control system according to claim 6, wherein said processing unit includes means for generating said priority information based on environmental information around said vehicle and said direct request.

8. The vehicle integrated control system according to claim 7, wherein said environmental information includes information related to a road on which said vehicle runs.

9. The vehicle integrated control system according to claim 7, wherein said environmental information includes information related to another vehicle in a neighborhood of said vehicle.

10. The vehicle integrated control system according to claim 6, wherein each said controller means comprises means for generating a control target based on said request even when the vehicle is under integrated control with said priority information used at each control unit.

11. The vehicle integrated control system according to claim 2, wherein each said controller generates a control target based on said request even when the vehicle is under integrated control with said priority information used at each control unit.

12. The vehicle integrated control system according to claim 3, wherein each said controller generates a control target based on said request even when the vehicle is under integrated control with said priority information used at each control unit.

13. The vehicle integrated control system according to claim 4, wherein each said controller generates a control target based on said request even when the vehicle is under integrated control with said priority information used at each control unit.

14. The vehicle integrated control system according to claim 7, wherein each said controller means comprises means for generating a control target based on said request even when the vehicle is under integrated control with said priority information used at each control unit.

15. The vehicle integrated control system according to claim 8, wherein each said controller means comprises means for generating a control target based on said request even when the vehicle is under integrated control with said priority information used at each control unit.

16. The vehicle integrated control system according to claim 9, wherein each said controller means comprises means for generating a control target based on said request even when the vehicle is under integrated control with said priority information used at each control unit.
